(19) United States
(12) Patent Application Publication
(10) Pub. No.: US 2020/0093707 A1
(43) Pub. Date: Mar. 26, 2020

(54) Pacifier and Teether Assembly and Method of Use

(71) Applicant: Lindsey Ferrell, Lakeland, TN (US)

(72) Inventor: Lindsey Ferrell, Lakeland, TN (US)

(21) Appl. No.: 16/140,020

(22) Filed: Sep. 24, 2018

(51) Int. Cl. A61J 17/00; A61J 17/02

(52) U.S. Cl. CPC A61J 17/008; A61J 17/02

(57) ABSTRACT

A pacifier and teether assembly is disclosed. In one embodiment, the pacifier and teether assembly comprises a nipple, a shield and a teether manufactured as a one-piece assembly comprising a single molded piece of material. In one example embodiment, the nipple and teether are each contiguous to the shield, wherein the shield has a first face opposite a second face. The nipple extends from the first face of the shield. The teether extends from the second face of the shield. In one example embodiment, the pacifier and teething ring assembly is made of 100% medical grade silicone. Such 100% medical grade silicone is free of BPA, PVC, phthalates and latex. A method for using a pacifier and teether assembly is also disclosed.

### BACKGROUND

Pacifiers are everyday items used in the daily care of infants. A pacifier, also known as a dummy, a binky or soother, is a rubber, plastic or silicone nipple given to an infant to suck upon to satisfy the infant's sucking reflex and to soothe and provide comfort to the infant. In its standard appearance, a pacifier has a nipple, a mouth shield and a handle. Various types of pacifiers are available for use including orthodontic pacifiers, round-tip pacifiers, silicone pacifiers, latex pacifiers, one-piece pacifiers and multiple baby pacifiers. Orthodontic pacifiers have nipples that are flattened at the bottom and rounded at the top. Such design provides the infant a natural sucking action as the pacifier flattens in the baby's mouth while the baby sucks. The orthodontic pacifier also reduces pressure on the developing teeth. Round-tip pacifiers have a nipple design that mimics the form of an actual nipple. Such design is desired as it is known to prevent nipple confusion for the infant. Other types of pacifiers, such as the silicone pacifiers, are used because they are sturdy and easy to clean while latex pacifiers are used because they are softer and more flexible. Additionally, pacifiers may be one-component or multiple components. One-piece pacifiers are made out of a single molded piece or component of material while multi-piece pacifiers have multiple components manufactured separately before being combined into a traditional pacifier design. The type of pacifier used depends on the particular child's age and development.

Additionally, teethers, also known as teething rings, are everyday items used in the daily care of infants. A teething ring or teether may be any chewable toy given to a teething infant as a soothing tool to help soothe inflamed gums during teething. Babies typically begin teething at around three to seven months of age. Teething rings or teethers are manufactured and sold in various shapes, colors or designs. The entire teethers or at least of portion of such teether is typically made of plastic, silicone or latex which may be chewed, sucked or gnawed on by the infant.

Although there are numerous types of pacifiers to use, each of the existing pacifiers has one commonality in that each provides a single function. Pacifiers allow for an infant to suck on the nipple of the pacifier allowing the infant to satisfy the infant's sucking reflex. Satisfying such sucking reflex provides comfort to the infant. Additionally, existing teethers provide a single function. They allow the infant to chew, gnaw or suck on the teether to help soothe inflamed gums ultimately providing comfort to the infant during a teething stage.

A pacifier and teether combo assembly that provides the dual function of satisfying the infant's sucking reflexes and soothing the infant's inflamed gums is desired. Such pacifier and teether combo assembly that is safe and effective would simplify the need for two products.

### BRIEF SUMMARY

A pacifier and teether assembly comprising a nipple, a shield, and a teether is disclosed. The pacifier and teether assembly may be manufactured as a one-piece assembly comprising a single molded piece of material. In one embodiment, the pacifier and teether assembly may be made of medical grade silicone, food grade silicone, natural rubber, latex, or plastic. In another embodiment, the pacifier and teether assembly is made of 100% medical grade silicone. In a still further embodiment, the assembly is free of BPA, PVC, phthalates and latex. In one embodiment, the nipple and teether are each contiguous to the shield having a first face opposite a second face. In one example embodiment, the nipple extends from the first face of the shield and the teether extends from the second face of the shield. The length of the pacifier and teether assembly may range from about 45 to 65 millimeters. In another embodiment, the length of the pacifier and teether assembly may be around 55 to 60 millimeters. In still a further embodiment, the length of the pacifier and teether assembly may be around 56 to 67 millimeters.

In one example embodiment, the pacifier and teether assembly comprise a nipple having a rounded tip, an elongated body and a heel portion. The heel portion of the nipple is contiguous to the first face of the shield. In one embodiment, the tip has diameter of about eleven to thirteen millimeters. In a further embodiment, the elongated body of the nipple has a diameter less than the diameter of the rounded tip. In a still further embodiment, the elongated body has a diameter of about ten to twelve millimeters. The nipple construction creates a substantially u-shaped inner channel.

In one embodiment, the shield is cylindrical and has as a height of about 6 millimeters and a diameter which ranges from about 46 to about 52 millimeters. In an example embodiment, the shield comprises a first and a second breathing hole symmetrically located on either side of the nipple.

In another example embodiment, the teether may be a continuous material which functions as a teether and a handle. In one embodiment, the teether comprises a plurality of beads, wherein each bead has a diameter of about six to ten millimeters. In another embodiment, each bead has a diameter of about eight millimeters. Other teether designs may be smooth, flat, beaded or combinations thereof.

In one embodiment, the assembly may be made using an injection machine. The mold used to make the assembly has two injection points where silicone is injected directly into the mold. A first injection point is at the nipple section of the mold and the second injection point is located on the teether section of the mold, opposite in the first injection point.

A method for using a pacifier and teether assembly is also disclosed. The method comprises the steps of: (a) obtaining a pacifier and teether combination system comprising a nipple, a shield and a teether, wherein the nipple, the shield, and the teether are made in one piece comprising the same material, and (b) using the pacifier and teether assembly to soothe an infant.

### BRIEF DESCRIPTION OF THE DRAWINGS

FIG. 1 depicts an angled, perspective view of a pacifier and teether assembly according to one example embodiment.

FIG. 2 is a view of the pacifier and teether assembly as shown in FIG. 1. In this view, the teether and shield are shown.

FIG. 3 depicts a side view of the pacifier and teether assembly as shown in FIG. 1. In this view, the nipple, shield and teether are shown.

FIG. 4 is another side view of the pacifier and teether assembly as shown in FIG. 1. In this view, the nipple, shield and teether are shown.

FIG. 5 depicts an angled, perspective view of a pacifier and teether assembly according to a second example embodiment.

FIG. 6 is a side view of a pacifier and teether assembly as shown in FIG. 5.

FIG. 7 is a perspective view of a pacifier and teether assembly as shown in FIG. 5.

FIG. 8 is a side view of a pacifier and teether assembly as shown in FIG. 5.

FIG. 9 is a perspective view of a pacifier and teether assembly according to a further example embodiment.

### DETAILED DESCRIPTION

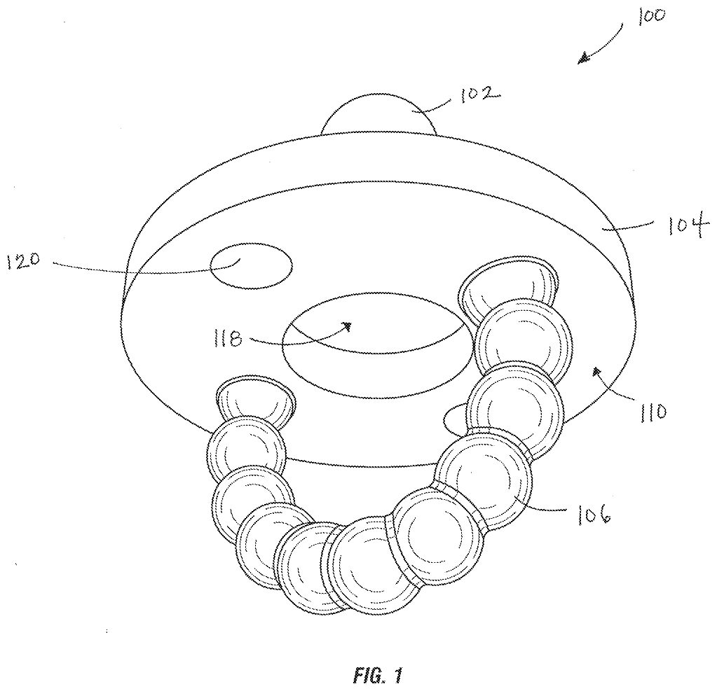

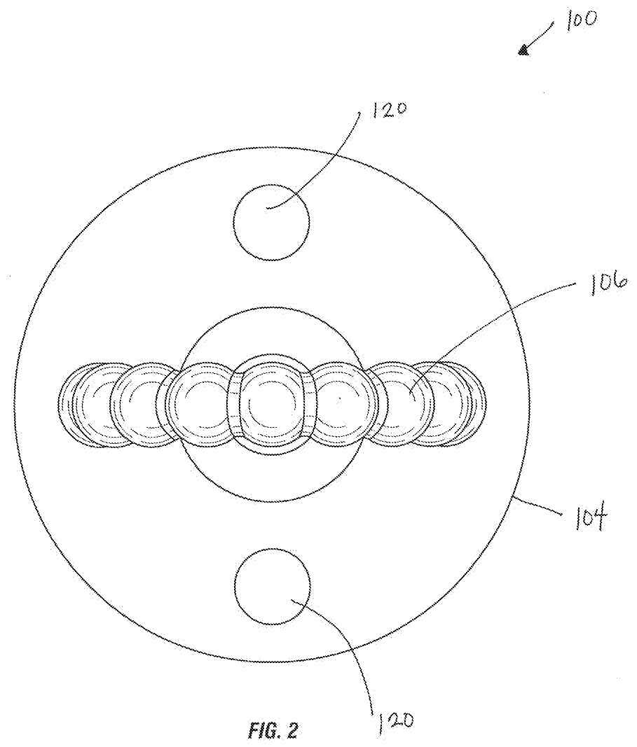

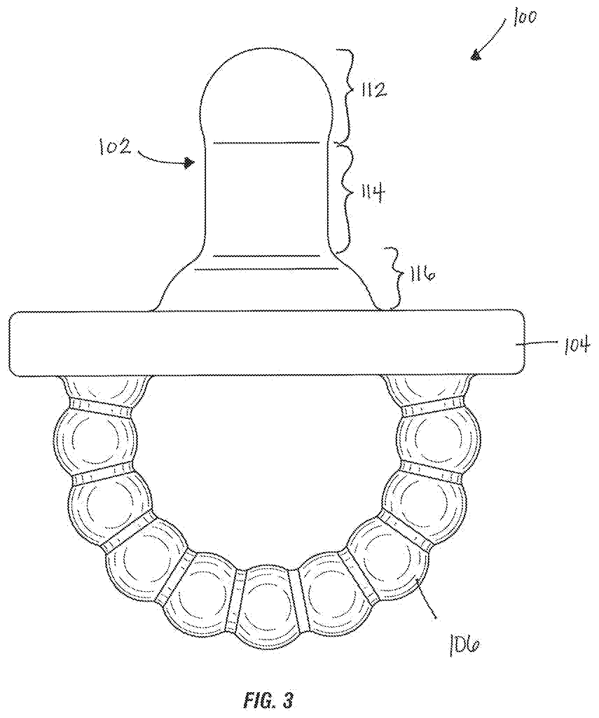

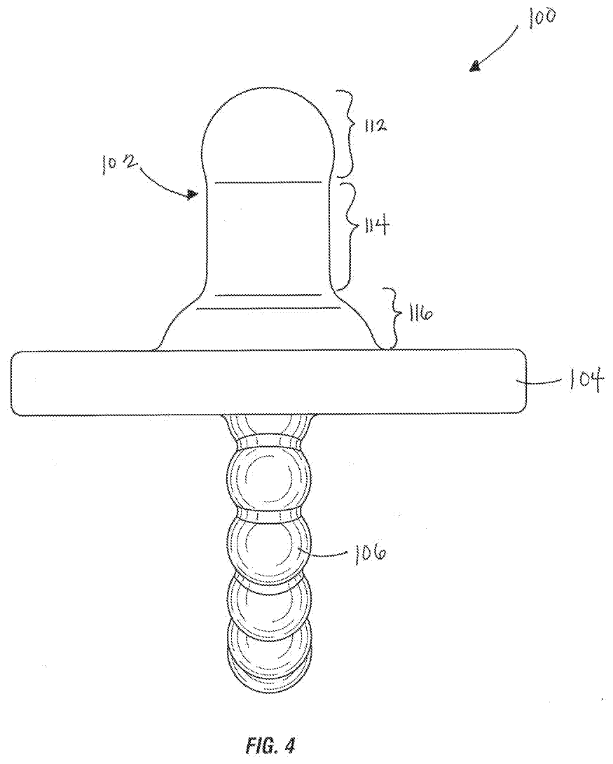

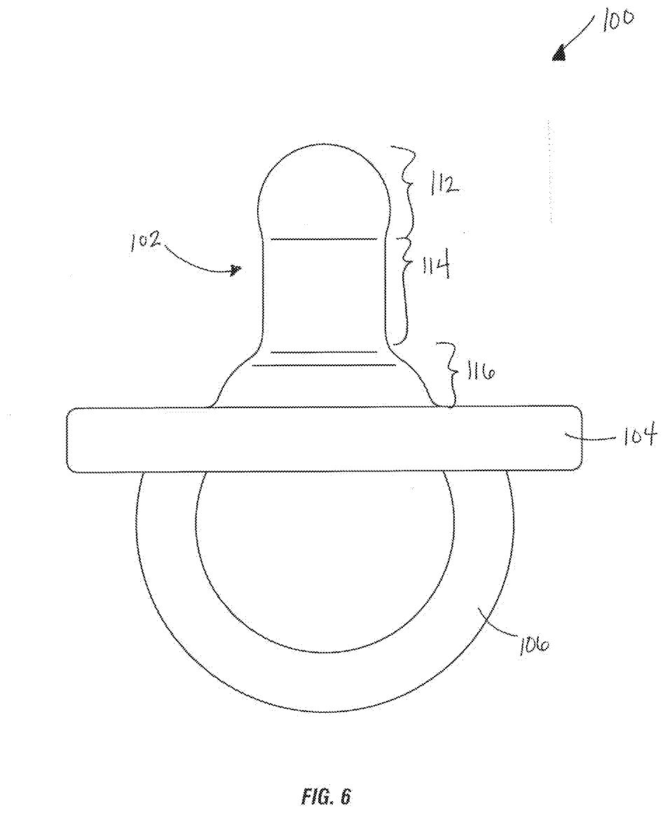

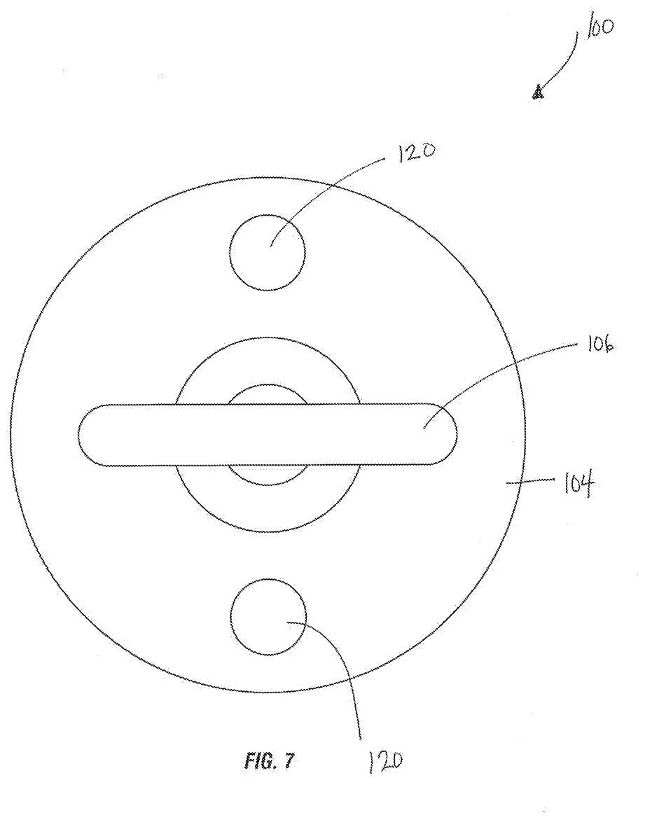

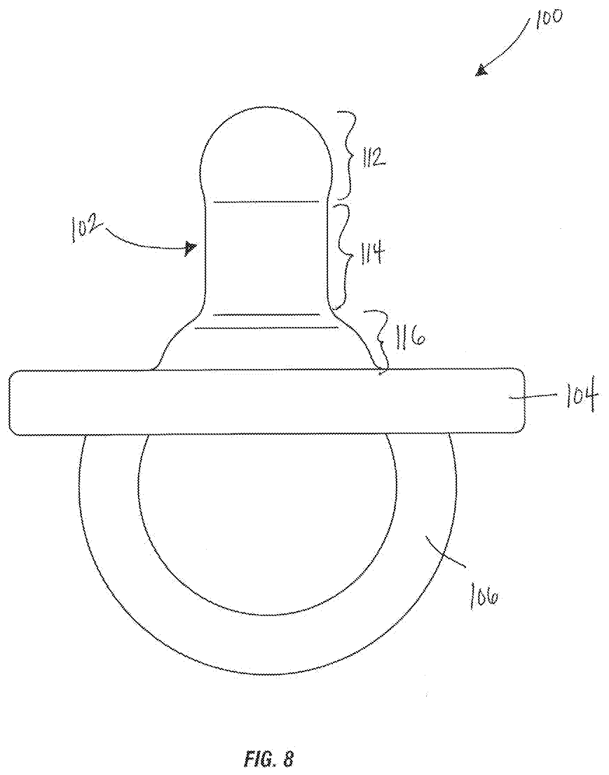

Referring to FIGS. 1-9, a pacifier and teether assembly 100 is disclosed. In one embodiment, the pacifier and teether assembly 100 comprises a nipple 102, a shield 104 and a teether 106 manufactured as a one-piece assembly comprising a single molded piece of material. In one example embodiment, the nipple and teether are each contiguous to the shield, wherein the shield 104 has a first face 108 opposite a second face 110. The nipple extends from the first face of the shield. The teether extends from the second face of the shield. In one embodiment, the length of the pacifier and teether assembly may range from about 45 to 65 millimeters. In a further embodiment, the length of the pacifier and teether assembly may be around 55 to 60 millimeters. In still a further embodiment, the length of the pacifier and teether assembly 100 may be around 56 to 57 millimeters

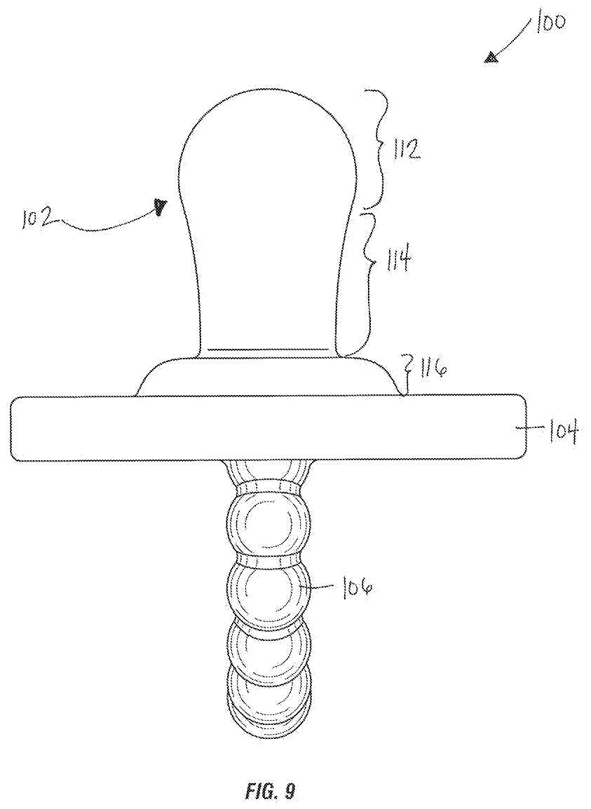

In one example embodiment, the nipple 102 has a tip 112, an elongated body 114, and a heel portion 116. In one embodiment, the heel portion of the nipple is contiguous to the first face of the shield. The tip may have a diameter of about eleven to thirteen millimeters. The elongated body of the nipple has a diameter less than the diameter of the rounded tip. In one embodiment, the elongated body has a diameter of about ten to twelve millimeters. In one embodiment, the tip and elongated body of the nipple may have varying shapes including a flat nipple shape or various round or curved nipple shapes. See FIG. 9 depicting an alternative nipple embodiment. The construction of the nipple, namely the tip and elongated body create a substantially u-shaped inner channel 118. The tip and body of the nipple may be popped in or inverted into the u-shaped inner channel when the pacifier portion of the assembly is not being used. Such inversion (or pop in feature) allows the tip and body of the nipple to remain sanitary.

In one example embodiment, the shield 104 is cylindrical in shape. In other embodiment, the shield may be varying shapes, such as butterfly or curved, as desired by one of skill in the art. In one embodiment, the shield has a height or thickness of about 5 to 6 millimeters. Other heights may be used as desired by one of skill in the art. The diameter of the shield may be about 52 millimeters; other diameters may be used as desired by one of skill in the art. Such height and diameter dimensions create a shield with ample surface area allowing the shield to be easily chewed on by a baby when the pacifier and teether assembly is being used. The shield's diameter allows for the creation of breathing holes 120 which allow ample ventilation as well as universal attachment for most pacifier clips. In one example embodiment, the shield comprises a first and second breathing hole symmetrically located on either side of the nipple. In one embodiment, the distance between the center of a first breathing hole to the center of a second breathing hole may be about 34 to 35 millimeters. The diameter of such first and second breathing holes may be about seven millimeters. In one example embodiment, the distance from the edge of first and second breathing hole (farthest from the nipple) and the circumference of the shield is about five to six millimeters.

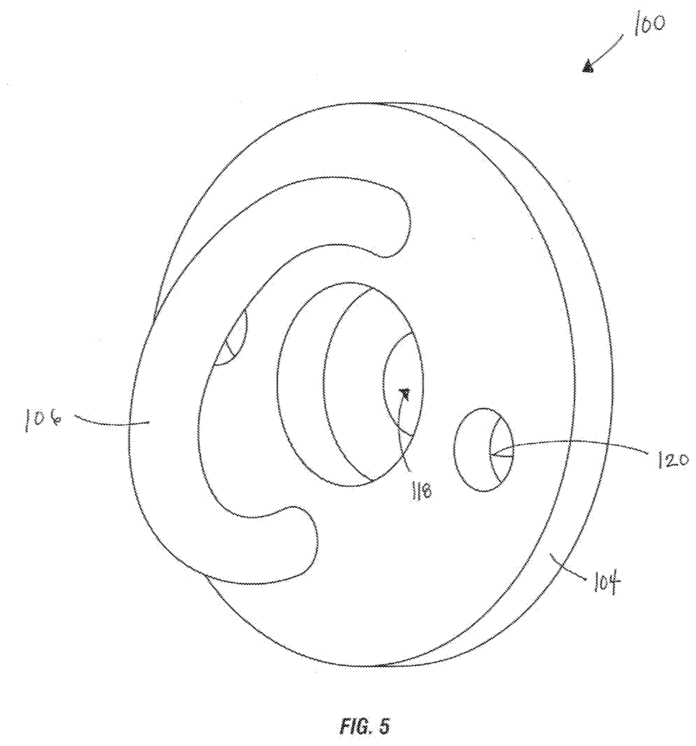

In one example embodiment, the teether 106, also known as a teething ring, is one continuous piece or ring extending from the second face of the shield. The teether may be chewed, gnawed or sucked on by the infant to provide comfort to the infant's gums during teething. The teether also functions as a handle of the assembly. In one embodiment, the teether may comprise a plurality of beads forming a beaded design (shown in FIGS. 1-5), wherein each bead of the design has a diameter of about six to ten millimeters. In one embodiment, each bead of the design has a diameter of about eight millimeters. Other teether designs may be used as desired by one of skill in the art. Other designs may be smooth, flat, circular or non-circular or any combination thereof as desired by one of skill in the art. FIGS. 5 to 8 depict a pacifier and teether assembly wherein the teether is non-beaded. Such teether may function as a handle; therefore, any teether design that allows for such holding function whether circular or not may be used as desired by one of skill in the art.

In one embodiment, the pacifier and teether assembly 100 is manufactured as one piece. The pacifier and teether assembly is made out of a single molded piece of material such as plastic, silicone or latex. The pacifier and teether assembly is made using an injection machine having two injection points where silicone is injected directly into the mold. The first injection point may be at the nipple section of the mold. At this first injection point, the material, such as silicone, is injected directly into the mold. The second injection point may be located on the teether section of the mold, opposite in the first injection point. The second injection point allows the release of air during production allowing the material to heat evenly throughout the mold during production. After injection of the material is complete, the assembly is allowed to cure. The one piece design minimizes the risk of choking due to the fact that there are not multiple components which may be easily separated.

In one example embodiment, the pacifier and teething ring assembly is made of 100% medical grade silicone. Medical grade silicone is softer than other grade silicone or materials. Such 100% medical grade silicone is free of BPA, PVC, phthalates and latex. In another embodiment, the pacifier and teether assembly is made of food grade silicone.

A method for using a pacifier and teether assembly, wherein the method comprises the steps of: (a) obtaining a pacifier and teether assembly comprising a nipple, a shield and a teether, wherein the nipple, the shield, and the teether assembly are manufactured as a single molded piece material, and (b) using the pacifier and teether assembly to soothe an infant.

Other embodiments of the disclosed technology will be apparent to those of skill in the art from consideration of the specification and practice of the technology disclosed herein. It is intended that the specification and the example embodiments be considered as exemplary embodiments only, with a true scope and spirit of the technology being indicated by the disclosure herein.

I claim:

1. A pacifier and teether assembly comprising a nipple, a shield, and a teether, wherein the assembly is a single molded piece of material.

2. The pacifier and teether assembly of claim 1, wherein the material is medical grade silicone, food grade silicone, natural rubber, latex, or plastic

3. The pacifier and teether assembly of claim 1, wherein the material is 100% medical grade silicone.

4. The pacifier and teether assembly of claim 1, wherein the nipple and teether are each contiguous to the shield having a first face opposite a second face, wherein the nipple extends from the first face of the shield and the teether extends from the second face of the shield.

5. The pacifier and teether assembly of claim 1, wherein the length of the pacifier and teether assembly ranges from about 45 to 65 millimeters.

6. The pacifier and teether assembly of claim 1, wherein the length of the pacifier and teether assembly is about 55 to 60 millimeters.

7. The pacifier and teether assembly of claim 1, wherein the nipple has a tip, an elongated body and a heel portion, wherein the heel portion of the nipple is contiguous to the first face of the shield.

8. The pacifier and teether assembly of claim 7, wherein the tip has diameter of about eleven to thirteen millimeters.

9. The pacifier and teether assembly of claim 7, wherein the elongated body of the nipple has a diameter less than the diameter of the rounded tip.

10. The pacifier and teether assembly of claim 7, wherein the elongated body has a diameter of about ten to twelve millimeters.

11. The pacifier and teether assembly of claim 7, wherein the rounded tip and elongated body of the nipple create a substantially u-shaped inner channel.

12. The pacifier and teether assembly of claim 1, wherein the shield is cylindrical, wherein the shield has as a height of about 6 millimeters and a diameter of about 52 millimeters, wherein the shield comprises a first and second breathing holes symmetrically located on either side of the nipple.

13. The pacifier and teether assembly of claim 1, wherein the teether has a plurality of beads, wherein each bead has a diameter of about six to ten millimeters.

14. The pacifier and teether assembly of claim 13, wherein each bead has a diameter of about eight millimeters.

15. The pacifier and teether assembly of claim 1, wherein the teether is smooth.

16. The pacifier and teether assembly of claim 1, wherein the teether is flat.

17. The pacifier and teether assembly of claim 1, wherein the assembly is made using an injection machine, wherein the a mold has two injection points where silicone is injected directly into the mold, wherein a first injection point is at the nipple section of the mold and the second injection point is located on the teether section of the mold, opposite in the first injection point.

18. The pacifier and teether assembly of claim 1, wherein the assembly is free of BPA, PVC, phthalates and latex.

19. A method for using a pacifier and teether assembly, wherein the method comprises the steps of: (a) obtaining a pacifier and teether assembly comprising a nipple, a shield and a teether, wherein the nipple, the shield, and the teether are manufactured in a single molded piece of material, and (b) using the pacifier and teether assembly to soothe an infant.
